(19) United States
(12) Patent Application Publication
(10) Pub. No.: US 2017/0205642 A1
(43) Pub. Date: Jul. 20, 2017

(54) Eye Examining System And Method For Examining Eyes

(71) Applicant: Oculus Optikgeraete GmbH, Wetzlar (DE)

(72) Inventors: Andreas Steinmueller, Wettenberg (DE); Stephan Degle, Jena (DE)

(21) Appl. No.: 15/405,951

(22) Filed: Jan. 13, 2017

(30) Foreign Application Priority Data
Jan. 14, 2016 (DE) 10 2016 000 233.6

(51) Int. Cl. G02C 13/00; G06T 7/70

(52) U.S. Cl. CPC G02C 13/003; G06T 7/70

(57) ABSTRACT

The invention relates to a method for examining a subject's eyes with an eye examining system as well as an eye examining system, eye examination symbols being made visible to at least one of the subject's eyes by means of a monitor of a display device of the eye examining system, the subject's eyes being recorded in conjunction with a spectacle frame by means of a camera of a camera device of the display device, the display device being controlled by a control apparatus of the eye examining system, a position of the spectacle frame being determined relative to the eyes by means of image processing.

### CROSS REFERENCE TO RELATED APPLICATION

This application claims the priority benefit of German Patent Application No. 10 2016 000 233.6 filed on Jan. 14, 2016, which is fully incorporated herein by reference.

### BACKGROUND OF THE INVENTION

The invention relates to a method for examining a subject's eyes with an eye examining system as well as an eye examining system, eye examination symbols being made visible to at least one of the subject's eyes by means of a display device of the eye examining system.

Such eye examining systems are well known and are regularly used for conducting eye examinations. The known display devices or rather monitors comprise a control device by means of which a user can control showing eye examination symbols on the monitor. Depending on the type of monitor, the monitor can also comprise a linear or circular polarization. The polarization of the monitor is regularly used for conducting eye examinations in conjunction with a trial frame or a phoropter. Furthermore, the eye examining system can comprise a camera device having a camera which can be used for measuring the subject's eyes, for example. A subjective refraction of the subject's eyes is determined by a user of the eye examining system showing various different eye examination symbols in conjunction with the subject looking through sample lenses of a phoropter or of a trial frame. Thus, various, commonly known eye examinations, for example examinations testing nearsightedness and farsightedness, can be conducted using the eye examining system.

Should such an eye examination lead to the conclusion that an ametropia requires a correction for either farsightedness or nearsightedness, these ametropias are regularly corrected by means of so-called varifocal lenses. In doing so, it is essential that the position of the varifocal lenses is arranged relative to the eye according to an adopted visual task with a spectacle frame or eyeglass frame, respectively. A visual axis of the eye when hyperopic, for example, is essentially horizontal while being inclined relative to a horizontal line via an eye movement when myopic. A varifocal lens or a spectacle lens, respectively, for correcting farsightedness and nearsightedness must be positioned relative to the eye in such a manner that an area of the varifocal lens for farsightedness lies in the area of a horizontally positioned visual axis and an area of the varifocal lens for nearsightedness lies in an inclined area of a visual axis of the eye. This positioning or rather adjustment of the varifocal lens is regularly carried out by manually measuring a relative position of the pupil to an eyeglass lens adjusted to the subject's head. Thus it becomes possible to apply a positioning mark to the varifocal lens, said positioning mark corresponding to a visual axis and on the basis of which an outer contour of the varifocal lens, which is adjusted to the spectacle frame, can be ground on the varifocal lens.

A particular disadvantage of the known method is that after having conducted an eye examination, in particular when varifocal lenses are required for correcting a determined ametropia, the varifocal lenses must be adjusted manually to a spectacle frame. Thus, devices are known which enable an optical detection of the subject's eyes in conjunction with a spectacle frame using a corresponding measurement. These devices must be acquired and used in dependence of the eye examining system, leading to additional costs and a high expenditure of time.

### SUMMARY OF THE INVENTION

Therefore, the object of the invention at hand is to propose a method for examining a subject's eyes with an eye examining system as well as an eye examining system by means of which ametropias can be corrected more easily.

This object is attained by an eye examining system and corresponding method disclosed herein. In the method for examining a subject's eyes with an eye examining system, eye examination symbols are made visible to at least one of the subject's eyes by means of a monitor of a display device of the eye examining system, the subject's eyes being recorded in conjunction with a spectacle frame by means of a camera of a camera device of the display device, the display device being controlled by a control apparatus of the eye examining system, a position of the spectacle frame being determined relative to the eyes by means of image processing.

By making eye examination symbols visible to a subject's eye or rather by showing eye examination symbols to a subject's eye, an eye examination is conducted by means of which a subjective refraction of the eye can be determined. On the basis of the subjective refraction of the eye or the subject's eyes, respectively, spectacle lenses, for example varifocal lenses, are chosen for correcting the corresponding ametropia of the eye. Furthermore, an eyeglass frame or spectacle frame, respectively, is adjusted to the subject's head, the subject's eyes being recorded in conjunction with the adjusted spectacle frame by a camera. The eye examining system therefore also comprises the spectacle frame. The control apparatus or rather a control device allows controlling the display device or rather the monitor, for example for also showing eye examination symbols. The control apparatus comprises means for data processing which allow image processing the image data sets recorded by the camera. The recording of the subject's eyes recorded by the camera in conjunction with the spectacle frame are now processed by the control apparatus in such manner that a position of the spectacle frame relative to the subject's eyes is determined. In particular, an evaluation or rather distance measurement is carried out for each eye's pupil relative to an inner contour of the spectacle frame or the spectacle lens frame. On the basis of this determined position, the required position of the spectacle lens in the inner spectacle frame can be determined by the control apparatus. A separate, manual measuring is then no longer necessary. Additionally, a further, additional device is not required to carry out this measurement. Indeed, the display device of the eye examining system alone can already be used for determining the position of the spectacle frame relative to the subject's eyes or rather pupils in the scope of an eye examination. In total, a pair of spectacles or correction of ametropias, respectively, can be adjusted cost-efficiently and with little expenditure of time.

A subjective refraction of the corresponding eye can be determined using a trial frame or a phoropter. The phoropter and the trial frame can also comprise color filters or polarization filters, which are each adjusted to a color display and/or a polarization of the monitor, so that monocular and binocular eye examinations can be conducted. If, for example, a phoropter or a trial frame is provided having linear or circular polarization, the display device of the eye examining system can be chosen so as to correspond to the polarization of the phoropter or the trial frame. Correcting a polarization, for example by means of a λ/4 filter, is therefore not required.

In a first step, a subjective refraction of the subject's eye can be determined by means of the eye examining system; in a second step, the position of the spectacle frame relative to the eyes can be determined by means of the eye examining system, the second step being able to directly follow the first step. The eye examination conducted in the first step can be extended to directly adjust the spectacle frame in conjunction with the spectacle lenses. The corresponding subject can then stay seated on a chair, for example, while the spectacle lenses are adjusted and does not have to move to a different location in order to get to a different device.

The determination of the position can be used for the relative positioning or adjustment, respectively, of the varifocal lenses within the spectacle frame. The varifocal lenses can be adjusted particularly exact relative to a subject's eyes.

In an embodiment of the method, it can be provided that a spectacle frame is chosen from a plurality of spectacle frames, a reference point being able to be determined at the chosen spectacle frame by the control apparatus by means of image processing. A subject can choose a spectacle frame according to their own preferences from a plurality of spectacle frames, for example, spectacle lenses being prepared or rather chosen for correcting ametropias for the chosen spectacle frame. For relatively positioning the spectacle frame and the eye's pupils, the control apparatus can detect a position of the pupils relative to the spectacle frame by means of image processing. It can be advantageous if the control apparatus determines a reference point at the chosen spectacle frame, by means of which the relative position of the spectacle frame and pupils can be described or defined, respectively. Generally, this reference point can be arranged at any location of the spectacle frame. Additionally, it can be intended to determine a plurality of reference points at the spectacle frame, for example. The reference points can be symmetrically positioned at the spectacle frame, relative to each other and in relation to the spectacle frame.

Furthermore, the control apparatus can determine constructive details of the spectacle frame by means of image processing and allocate said constructive details to a reference point. Visible constructive details can be contours of the spectacle frame, visible differences between lightness and darkness or differences in color, for example, in a recording or an image data set, respectively. Additionally, details, such as screws, fixing points or the like, can be a constructive detail of the spectacle frame. These visible constructive details can be recognized by means of image processing, the control apparatus being able to allocate a reference point to the corresponding detail. Optionally, it is possible to manually allocate a reference point to the constructive details.

The control apparatus can also comprise a data bank having data sets of spectacle frames, the control apparatus further being able to compare an image data set recorded by the camera of the spectacle frame on the subject's head to the image data sets of the data bank, the control apparatus being able to allocate a reference point when the image data sets of the spectacle frame on the subject's head correspond to each other. By comparing images of a recording of the spectacle frame on the subject's head to recordings of the spectacle frame in the data bank, the spectacle frame on the subject's head can possibly be recognized in such a manner that this spectacle frame can be allocated to a producer, model and/or type. Furthermore, it can be provided that the image data sets in the data bank or the spectacle frames, respectively, each already comprise reference points. Therefore, it is possible to record any spectacle frame with the camera, allocate a reference point thereto and save the corresponding image data set in the data bank. This spectacle frame is consequently calibrated for use with the eye examining system. In conjunction with the image data set, further data sets can be saved in the data bank along with spectacle frame measurements, the producer's details, etc.

The spectacle frame or rather the spectacle frame chosen by the subject can be provided with a reference marking, the control apparatus being able to determine the reference marking as a reference point. The reference marking can be temporarily applied to the spectacle frame, the reference marking being a sticker or a different type of visual marking, for example. The control apparatus can then recognize the reference marking and fix it as a reference point. The reference marking can always be applied at the same position, even on differently realized spectacle frames, for example at an apex of the spectacle frame. The reference marking can also be a horizontal and/or vertical scale which is applied to the spectacle frame.

In a like manner, the spectacle frame can be formed by a trial frame. The measurements of the trial frame can already be saved in the control apparatus. Thus, it is possible to already determine a position of the spectacle frame or rather the trial frame relative to the subject's eyes during an eye examination and to later use these position data for adjusting the spectacle lenses. It is also possible to use the constructive details of the trial frame as a reference marking for fixing a reference point.

A frontal image can be recorded in relation to the subject's head and preferably after a sagittal image can be recorded, or vice versa. The frontally recorded image can serve for determining the position of the spectacle frame relative to the subject's pupil, the sagittal image recording serving for the exemplary determination of a corneal vertex distance or a spectacle frame tilt. The sagittal image can simply be recorded by the subject turning or horizontally tilting their head by 90° relative to an optical axis of the camera. Two sagittal image recordings can each also be recorded from both sides of the head by means of the camera and be further processed by the control apparatus. In the case of a sagittal image recording, the control apparatus can determine reference points as in frontal image recordings.

It is advantageous if a relative distance of the spectacle frame and the camera is determined. The relative distance can be determined by means of triangulation, for example. Thus, a scale at the spectacle frame or a known reference point distance at the spectacle frame can be used for evaluating the relative distance by means of the control apparatus. Moreover, a relative distance, e.g. when the display device or rather the camera and the subject are stationarily positioned, can be provided as being known during an eye examination so that the relative distance can be saved in the control apparatus. The relative distance can in turn be used for evaluating a pupil distance, for example, or a distance from the reference point to the pupil.

In the scope of the method, spectacle frame measurements, a pupil distance, centering point distances, an adjusting height, a corneal vertex distance, a frame tilt, and/or frame lens tilt can be recorded by the camera and be determined by the control apparatus by means of image processing.

Additionally, a position can be comparatively determined using a reference spectacle frame of the eye examining system and a subject's own pair of spectacles. The subject's own pair of spectacles can be a pair of glasses which is already adjusted to the subject's eyes. By comparatively determining a position or rather measurement, examining a suitability of the subject's own pair of glasses or the reference spectacle frame becomes possible.

In the eye examining system according to the invention for examining a subject's eyes, the eye examining system comprises at least one spectacle frame and a display device, the display device comprising a monitor by means of which eye examination symbols are made visible to at least one of the subject's eyes, the display device comprising a camera device having a camera by means of which the subject's eyes can be recorded in conjunction with the spectacle frame, the eye examining system comprising a control apparatus by means of which the display device can be controlled, a position of the spectacle frame being able to be determined using the control apparatus relative to the eyes by means of image processing. The advantageous description of the method according to the invention is referred to for the advantages of the eye examining system according to the invention.

It is also particularly advantageous if the spectacle frame comprises reference markings, preferably horizontal and vertical scales. The spectacle frame can be a trial frame, for example, which already comprises these scales. A position of the pupils relative to the spectacle frame or rather the scales is then particularly easy to determine.

The monitor and the camera can be arranged in a shared housing of the display device. The eye examining system can then be handled particularly easily since it is no longer required to have several devices which are coupled to but still distanced from one another for conducting an eye examination and for adjusting a pair of glasses.

The monitor can be backlit, the display device being a stationary display device for testing farsightedness, whose display surface size is designed for conducting eye examinations at a seeing distance of 3 m to 10 m, preferably 4 m to 8 m, and/or is a display device for testing nearsightedness for mobile use, whose display surface size is designed for conducting eye examinations at a seeing distance of 10 cm to 3 m, preferably 30 cm to 1 m. The display device for testing farsightedness can be used for showing eye examination symbols for testing farsightedness and the display device for testing nearsightedness is used for showing eye examination symbols for testing nearsightedness. Both display devices can be used separately or in conjunction with each another as an eye examining system. The display device for testing farsightedness can preferably be set up in a stationary manner or be mounted to a wall relative to the subject at the seeing distance stated above. If the subject is positioned at a defined seeing distance relative to the display device for testing farsightedness when conducting an eye examination, the seeing distance to the display device for testing farsightedness can be exactly determined. Correspondingly, a display surface size of the display device for testing farsightedness can then be many times larger than a display surface size of the display device for testing nearsightedness, since the eye examination symbols displayed on the display surface of the display device for testing farsightedness may possibly be comparatively larger. The display device for testing nearsightedness can also be used movably so that it can be placed or held relative to the subject's eyes at any possible distance within the seeing distance stated above by a user or the subject. The display device for testing farsightedness as well as the display device for testing nearsightedness can be remote controlled by a user via the control apparatus. The control apparatus can comprise a control device for remote controlling. Further embodiments of the eye examining system can be taken from the description of the method provided herein.

In the following, a preferred embodiment of the invention is further described in reference to the attached drawings.

### BRIEF DESCRIPTION OF THE DRAWINGS

In the drawings,

FIG. 1 shows a front view of a display device;

FIG. 2 shows a front view of a spectacle frame;

FIG. 3 shows a lateral view of the spectacle frame.

FIG. 4 shows a block diagram of the eye examination system.

### DETAILED DESCRIPTION OF THE EXAMPLE EMBODIMENTS

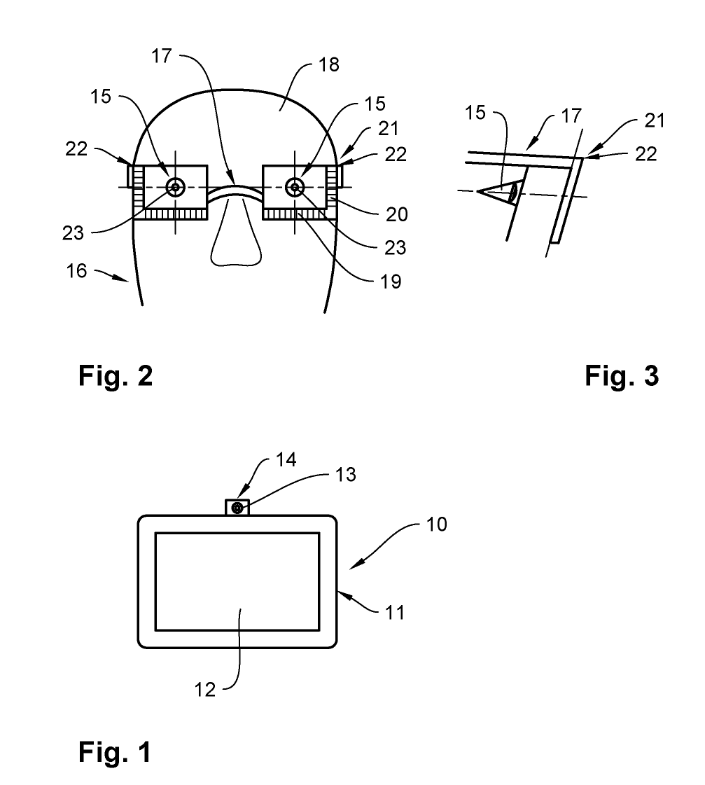

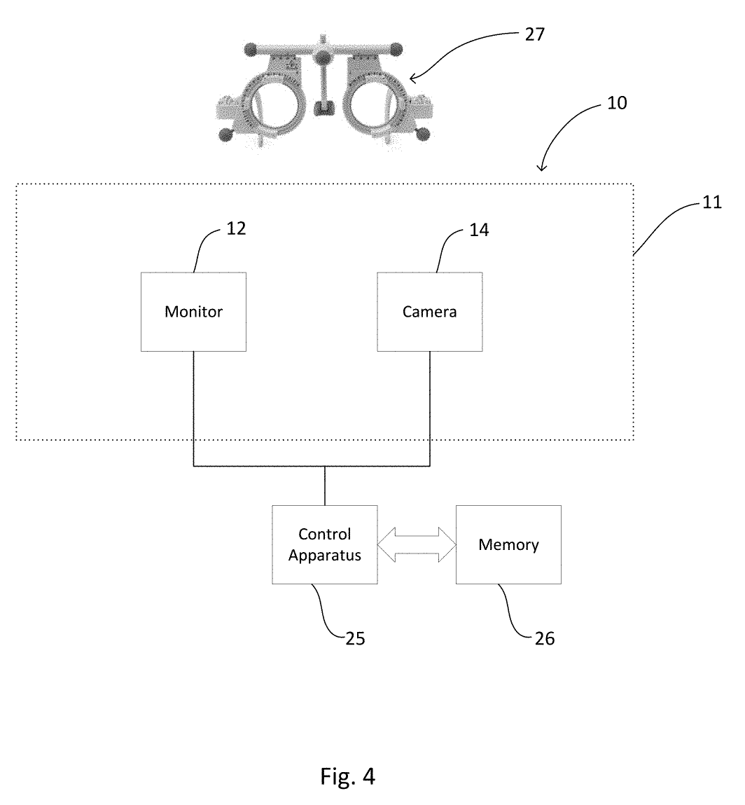

A synopsis of the FIGS. 1 to 4 show an eye examining system 10 having a display device 11 which comprises a backlit monitor 12 as a type of television or tablet computer, a camera device 14 having a camera 13 which can record a subject's 16 eyes 15 in conjunction with a spectacle frame 17 or rather a pair of glasses, a control apparatus 25 which can control the camera 13 and monitor 12, and a memory 26 which can be accessed by the control apparatus 25 to store and retrieve recorded data and data stored in a data bank. The spectacle frame 17 is comprised in the eye examining system or rather is a component thereof. Eye examination symbols are shown to the subject 16 using the monitor 12 in order to determine a subjective refraction of the corresponding eye 15 with the spectacle frame 17, which can be a trial frame 27 or a phoropter as shown by way of example in FIG. 4. Directly after this, varifocal lenses are adjusted or rather varifocal lenses are adjusted relative to the eyes 15 using the display device 11 and the spectacle frame 17. This occurs by means of a frontal recording of the subject's 16 eyes 15 in conjunction with the spectacle frame 17. Optionally, the subject 16 can turn their head 18 by 90° so that the head 18 turned by 90° can be recorded from the side in conjunction with the spectacle frame 17 by means of the camera 13 according to the drawing in FIG. 3.

The spectacle frame 17 has horizontal scales 19 and vertical scales 20. By means of the scales 19 and 20, a distance from the camera 13 to the spectacle frame 17 can be evaluated via triangulation by means of image processing. Furthermore, a corner 21 at the spectacle frame 17 can form a reference point 22, an already known relative distance of the reference points 22 being able to be used for evaluating the distance to the camera 13. Furthermore, a fit of the spectacle frame 17 on the subject's 16 head 18 can be examined by means of the scales 19 and 20. Pupils 23 of the eyes 15 can also be recognized by means image processing so that a position of the spectacle frame 17 relative to the pupils 23 or the eyes 15, respectively, can be easily determined. Generally, any spectacle frame or pair of glasses, respectively, by means of which a position can be determined, can be used besides the spectacle frame 17 shown here. In particular, frame measurements, a pupil distance, centering point distances, an adjusting height, a corneal vertex distance, a frame tilt and a frame lens angle can be detected by the camera 13 and be determined by means of image processing using the control apparatus.

1. A method for examining a subject's eyes with an eye examining system comprising the steps of:
displaying eye examination symbols to at least one of the subject's eyes on a monitor of a display device of the eye examining system
determining a position of a spectacle frame relative to at least one eye of the patient using image processing;
recording the subject's eyes in conjunction with a spectacle frame of the eye examining system using a camera of a camera device of the display device, the display device being controlled by a control apparatus of the eye examining system.

2. The method according to claim 1, further comprising the step of determining a subjective refraction of the at least one of the subject's eyes using a trial frame or a phoropter.

3. The method according to claim 1, further comprising the steps of initially determining the subjective refraction of the at least one of the subject's eyes with the eye examining system and, subsequently determining the position of the spectacle frame relative to the at least one eye with the eye examining system, the step of determining the subjective refraction being directly followed by the step of determining the position of the spectacle frame.

4. The method according to claim 1, further comprising the step of using the determined position for the spectacle frame relative to at least one eye of the patient for relatively positioning varifocal lenses within the spectacle frame.

5. The method according to claim 1, further comprising the steps of choosing a spectacle frame from a plurality of spectacle frames, and determining a reference point for the chosen spectacle frame by image processing with the control apparatus.

6. The method according to claim 1, further comprising the steps of determining at least one visible constructive detail of the spectacle frame and allocating a reference point to the at least one visible constructive detail with image processing.

7. The method according to claim 1, further comprising the steps of comparing an image data set of the spectacle frame recorded by a camera to an image data set in a data bank, and allocating a reference point to the spectacle frame when the image data set of the spectacle frame corresponds to the image data set in the data bank.

8. The method according to claim 1, further comprising the steps of providing a reference marking on the spectacle frame and determining the reference marking as a reference point with the control apparatus.

9. The method according to claim 1, further comprising the step of forming the spectacle frame with a trial frame.

10. The method according to claim 1, further comprising the step of recording a frontal image and a sagittal image of the subject's head.

11. The method according to claim 1, further comprising the step of determining a relative distance between the spectacle frame and the camera.

12. The method according to claim 1, further comprising the steps of recording and at least one of a spectacle frame measurement, a pupil distance, a centering point distance, an adjusting height, a corneal vertex distance, a frame tilt, and a frame lens tilt with the camera using image processing.

13. The method according to claim 1, further comprising the step of determining a comparative position using a reference spectacle frame of the eye examining system and a pair of spectacles previously used by the subject.

14. An eye examining system for examining a subject's eyes, the eye examining system comprising:
at least one spectacle frame
a display device, the display device comprising a monitor configured to display eye examination symbols to at least one of the subject's eyes, and a camera device having a camera configured to record the at least one of the subject's eyes in conjunction with the at least one spectacle frame; and
a control apparatus configured to control the display device to determine a position of the spectacle frame relative to the at least one eye using image processing.

15. The eye examining system according to claim 14, wherein the spectacle frame comprises reference markings including a horizontal and a vertical scale.

16. The eye examining system according to claim 14, wherein the monitor and the camera are arranged in a shared housing of the display device.

17. The eye examining system according to claim 14, wherein the monitor is backlit, the display device is at least one of a stationary display device for testing farsightedness, having a display surface size designed for conducting eye examinations at a seeing distance of 3 m to 10 m, and a mobile display device for testing nearsightedness having a display surface size designed for conducting eye examinations at a seeing distance of 10 cm to 3 m.
